(19) United States
(12) Patent Application Publication
(10) Pub. No.: US 2008/0216598 A1
(43) Pub. Date: Sep. 11, 2008

(54) Coupling shaft adaptor for harmonic balancer

(76) Inventor: David L. Roberts, Keller, TX (US)

Correspondence Address: LYNN E BARBER, P O BOX 16528, FORT WORTH, TX, 76162, US

(21) Appl. No.: 11/714,358

(22) Filed: Mar. 6, 2007

(51) Int. Cl. F16F 15/30

(52) U.S. Cl. 74/574.1

(57) ABSTRACT

An adaptor that may be installed on a harmonic balancer to enable temporary stopping of the belts on the pulley connected to the harmonic balancer when a substantial increase in power is desired, but which can then enable the belts to be functional again.

### BACKGROUND OF THE INVENTION

1. Field of the Invention

This invention relates to harmonic balancers used in vehicles, and in particular, relates to a coupling shaft adaptor that is attachable to a harmonic balancer.

2. Description of the Related Art

Harmonic balancers (also called crank pulley dampers, torsional dampers or vibration dampers) are devices connected to the crankshaft of an engine to reduce torsional vibration that occurs when the automotive cylinders fire. Harmonic balancers are designed to prolong the engine life by reducing wear on the main bearings and main journals and preventing crankshaft failure. While net engine output can be increased without harmonic balancers, they are still generally included even in high performance cars so that the cars can comply with regulations and/or be safer to drive.

The harmonic balancer is made up of three parts. The inner part is bolted to the crankshaft. The center part is a rubber ring which dampens crankshaft vibrations, and the outer part has pulley cuts for the drive and other belts. Drive belts provide power to engine-mounted accessories like the power steering pump, air conditioning compressor, mechanical cooling fan, and air injection pump. These belts cause there to be a drag on the engine due to the attached turning belts, but as discussed above, it is dangerous and sometimes illegal to remove the harmonic balancer.

While serious auto enthusiasts, such as hotrodders, or others desiring a temporary burst of horsepower would like to remove the drag from the harmonic balancer and attached belts when the extra horsepower is needed, there is now no way to easily and reversibly cause the various belts to stop turning and divert the added energy to forward motion of the vehicle without removing the belts. Previously, vehicle users have also tried means for increasing horsepower such as nitrous kits, in which the nitrous oxide goes inside the motor for extra horsepower, or superchargers, turbocharges or differential cam shafts.

Electromagnetic clutches have been used to turn on the air conditioners and fans. The invention herein allows the belts to be turned off to provide the extra horsepower.

It is therefore an object of the invention to provide a coupling shaft adaptor, particularly for hot-rod enthusiasts, that can allow the belts to temporarily stop turning for extra horse power.

Other objects and advantages will be more fully apparent from the following disclosure and appended claims.

### SUMMARY OF THE INVENTION

The invention herein is a coupling shaft adaptor that may be installed on a harmonic balancer to enable temporary stopping of the belts on the pulley connected to the harmonic balancer when a substantial increase in power is desired, but which can then enable vehicle's belts to function normally.

Other objects and features of the inventions will be more fully apparent from the following disclosure and appended claims.

### BRIEF DESCRIPTION OF THE DRAWINGS

FIG. 1 is an exploded view of the coupling shaft adaptor in relationship to vehicle components;

FIG. 2 is a perspective view of a first embodiment of the coupling shaft adaptor of the invention.

FIG. 3 is a perspective view of a second embodiment of the coupling shaft adaptor of the invention.

FIG. 4 is a perspective view of a second embodiment of the coupling shaft adaptor of the invention.

### DETAILED DESCRIPTION OF THE INVENTION AND PREFERRED EMBODIMENTS THEREOF

The present invention is a coupling shaft adaptor that is attached to a vehicle's harmonic balancer and allows the user of the vehicle to temporarily stop all pulleys and belts and gain an added burst of power. The coupling shaft adapter of the invention allows an added electromagnetic clutch to stop the pulleys and associated belts from turning when the clutch is disengaged, and thus provide the extra horsepower.

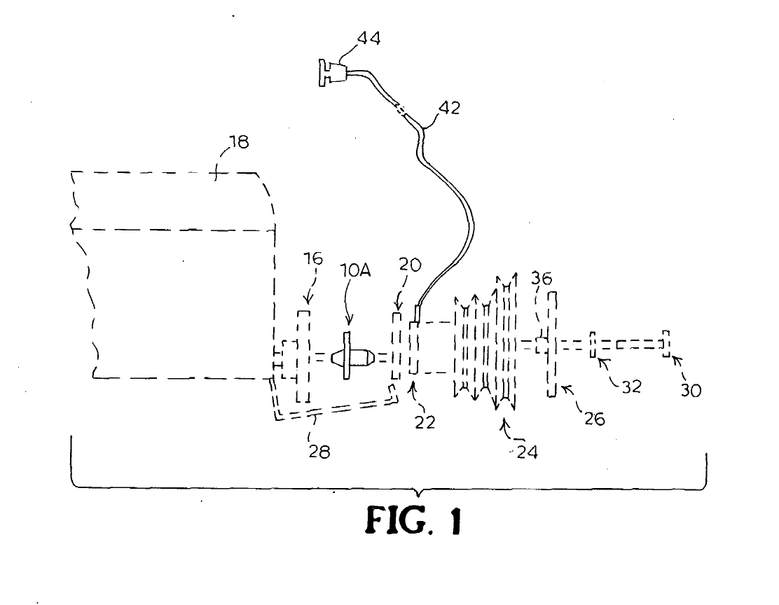

Referring now to the Figures, the coupling shaft adaptor 10A,B,C shown in FIGS. 1-4 comprises a shaft 12 in all embodiments. In addition, the coupling shaft adaptor 10A,B in the first and second embodiment comprises an adaptor plate 14. Details of the specific embodiments are discussed below.

FIG. 1 shows the arrangement of the relevant components of the vehicle, including the harmonic balancer 16, and shows the placement of the coupling shaft adaptor 10A,B,C of the invention. The adaptor 10A,B,C is positioned between the harmonic balancer 16, which is connected to the engine 18, and the motor as known in the art, which includes the electromagnet holder 20, the electromagnet 22, the pulley 24 and the clutch disk Thus, the electromagnet holder 20 is attached to the engine 18 through the coupling shaft adaptor 10A,B,C. A brace or bracket 28 is attached to the engine 18 and the electromagnet holder 20 to keep the electromagnet holder 20 and electromagnet 22 from spinning. The electromagnet holder 20 and electromagnet 22 are held stationary while the coupling shaft adaptor 10A,B,C of the invention and the pulley 24 turn free.

In a vehicle as known in the art, the belt (not shown) is connected to the AC clutch, of which the clutch disk 26 is part, and then to the electromagnet 22 and pulley 24. The bolt 30 and washer 32 hold the electromagnet clutch disk 26 and pulley 24 to the adaptor of the invention, which is bolted to the harmonic balancer 16 with the bolts known in the art, except that the coupling shaft adaptor 10A,B,C of the invention is positioned between the harmonic balancer 16 and the electromagnet 22/electromagnet holder 20. The adaptor plate 14 of the coupling shaft adaptor in the first and second embodiments has holes 34 that bolts go through to bolt the adaptor 10 to the harmonic balancer 16. Because the adaptor plate 14 found in these embodiments of the invention fits into a depression in the harmonic balancer 16 and the shaft 12 extends into the existent bores of the remaining components of the motor, the adaptor 10A,B even with a plate 14 does not take up any needed space nor cause any relocation of the motor components when the adaptor 10A,B is assembled together with an existing vehicle's components as discussed herein, and all components are lined up together as shown. As known in the art, the electromagnet holder has a bearing press fitted into the electromagnet holder, which is then press-fitted on to the end of the coupling shaft, keeping the electromagnet and pulley which are bolted to the electromagnet holder lined up.

The adaptor 10A,B,C of the invention is preferably machined from metal, such as steel with the central shaft 12 being pressed fit into a central hole in the adaptor plate 14, if present. The invention may also be made of plastic or fiber carbon or aluminum or cast iron as is known in the art of manufacturing.

Referring now in more detail to the structure of the adaptor 10A,B,C of the invention, in all embodiments of the invention herein, the adaptor comprises a means of attachment to a harmonic balancer 16, which means may be varied depending on the particular vehicle structure and component arrangement, and in particular, the structure of the harmonic balancer therein. Generally, however, this means of attachment to the harmonic balancer 16 comprises at least a shaft 12 as set forth above.

In a first embodiment, the adaptor 10A of the invention also comprises an adaptor plate 14, which is preferably a circular generally planar metal plate, in which there is a plurality of holes 34 for bolting the adaptor 10A to a particular harmonic balancer 16. The number and arrangement of holes 34 in the adaptor plate 14 are tailored to the particular harmonic balancer 16. The thickness of the adaptor plate 14 is adjusted for the particular vehicle pulley arrangement so that once the adaptor 10A is installed, the pulley(s) are lined up to their original position and fully functional when turned on.

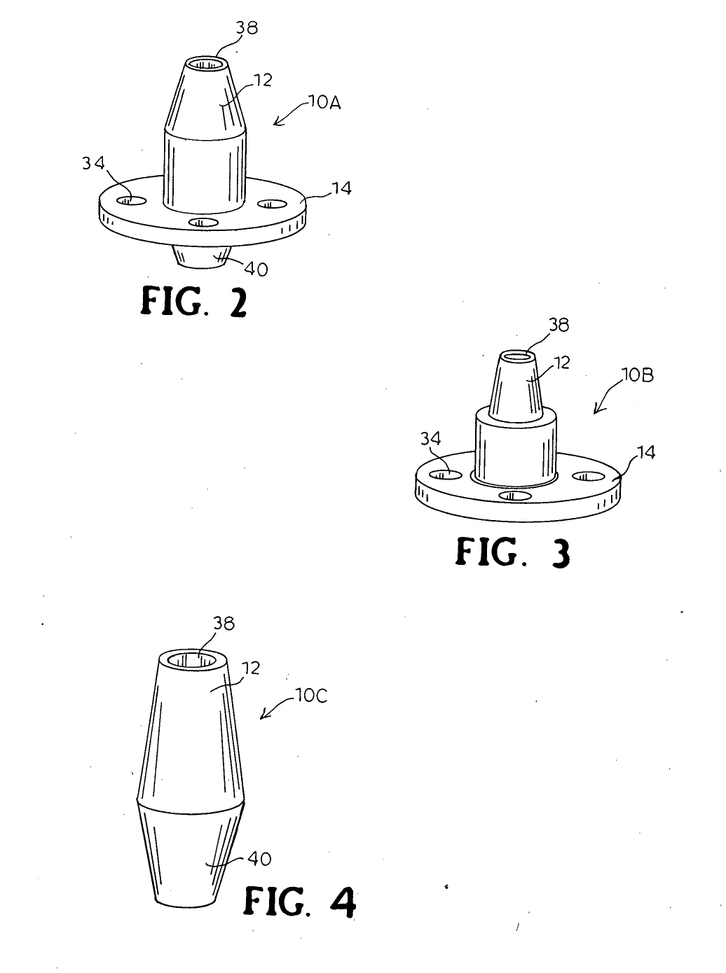

In the first preferred embodiment of the adaptor 10A of the invention (FIG. 2) the shaft 12 is elongated and protrudes from one side of the plate to fit within the hollow shaft 36 that extends from the electromagnetic clutch disk 26. Thus, the elongated shaft 12 is manufactured to have a length and thickness to fit between the harmonic balancer 16 and attach to the electromagnetic clutch disk 26. The elongated shaft 12 has a threaded bore 38 so that the adaptor 10A may be bolted to the electromagnet 22 and pulley 24. A Woodruff key (not shown) as known in the art is used to keep the pulley 24 from spinning on the elongated shaft 12. This embodiment of the adaptor 10A also has a shorter shaft 40 protruding from the opposite side of the plate to extend into the harmonic balancer 16 and line up the axial center of the adaptor 10A with that of the remaining components.

In a second alternate embodiment (FIG. 3), the adaptor 10B of the invention has only the flange and the elongated shaft. This adaptor 10B, while not having the shorter shaft is useful for most harmonic balancers 16 and allows easy attachment of the adaptor plate 14 to a harmonic balancer 16 and to the clutch disk 26.

In a third alternate embodiment (FIG. 4), the adaptor 10C of the invention has the elongated shaft 12 and the short shaft 40 but does not have a flange. This adaptor 10C may be attached to the harmonic balancer 16 by placing a bolt 30 through the center and shaft 36 of the pulley clutch disk 26. This bolt is the same bolt already being used to bolt the harmonic balancer to the crank shaft. To install the invention, this bolt is removed and the adaptor 10C of the invention is pressed into the harmonic balancer and the bolt is then put through the adaptor 10C and bolted to the crank shaft to hold the adaptor 10C in place.

Thus, the electromagnetic clutch and pulley are connected to the harmonic balancer by the adaptor 10A,B,C of the invention. The adaptor of the invention 10A,B,C is connected by its position of attachment to the harmonic balancer to the wire that protrudes from the electromagnet 22 and thus to an electric wire 42 that connects to an electric switch 44 (FIG. 1). The electric wire 42 coming from the electromagnet 22 is connected to an on-off switch 44. When the switch 44 is turned on, power is sent to the electromagnet and the clutch disk is drawn against the pulleys so that the pulleys can turn, and when switch 44 is turned off, the pulleys cannot turn. When the pulleys cannot turn, this causes all turning off of the water pump, air conditioner, power steering, alternator and radiator fan (not shown) so that extra horsepower is available to the vehicle.

Harmonic balancers constructed as known in the art may be retrofitted with the adaptor of the invention. For example, the means of attachment of the adaptor to the harmonic balancer is altered as fits the particularly harmonic balancers, such as adjustments in the number or position of bolts, the size and shape of the adaptor shafts, and the size and shape of the flange, as well as the selection originally of which of the embodiments of the adaptor to use.

The invention is particularly useful for hot-rodders and show cars and for those who wish an added burst of power for climbing steep hills and the like. Because the pulleys serve useful functions, such as cooling the engine, it is important that the user be able to switch the pulleys back on again so that the engine will not overheat. Optionally, the invention may also include heat sensors as known in the art so that the user does not unwittingly cause malfunction of the vehicle due to the overheating.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A coupling shaft adaptor, comprising:
a) a shaft having a hollow bore, which shaft attaches to a harmonic balancer, electromagnet, pulley and electromagnet clutch;
b) a switch; and
b) a wire connected from the electromagnet to the switch, wherein when the switch is turned off the pulley stops turning.

2. The coupling shaft adaptor of claim 1, further comprising an adaptor plate on the shaft that is attached to the harmonic balancer.

3. The coupling shaft adaptor of claim 2, further comprising holes in the adaptor plate for attachment to the harmonic balancer.
